(19) United States
(12) Patent Application Publication
(10) Pub. No.: US 2004/0026875 A1
(43) Pub. Date: Feb. 12, 2004

(54) Shutter door seal

(76) Inventor: Henry J. Banas, Gales Ferry, CT (US)

Correspondence Address: Office Of Counsel, Bldg 112T, Naval Undersea Warfare Center, Division, Newport, 1176 Howell Street, Newport, RI, 02841-1708, US

(21) Appl. No.: 10/214,549

(22) Filed: Aug. 8, 2002

(51) Int. Cl. F16J 15/50

(52) U.S. Cl. 277/628

(57) ABSTRACT

A sealing assembly is disclosed for closing a gap between a hull wall and a shutter door of a vessel. The sealing assembly includes a metal retainer member having a mounting block portion and a gap-closing portion extending from the mounting block portion. The mounting block portion is mounted to the hull wall and includes a slot formed therein parallel to the hull wall. The gap-closing portion has a tapered surface and a flat surface such that the flat surface is flush with sea-exposed surfaces of each of the hull wall and the shutter door. A resilient rubber member is provided having at least a part thereof secured within the slot of the mounting block portion and a remainder thereof secured to the tapered surface of the gap-closing portion of the retainer member with an adhesive. The resilient member fills the portion of the gap not closed by the gap-closing portion of the retainer.

### STATEMENT OF GOVERNMENT INTEREST

The invention described herein may be manufactured and used by or for the Government of the United States of America for governmental purposes without the payment of any royalties thereon or therefor.

### CROSS REFERENCE TO OTHER PATENT APPLICATIONS

Not applicable.

### BACKGROUND OF THE INVENTION

(1) Field of the Invention

This invention generally relates to a seal assembly for a sea vessel and more particularly to an improved seal assembly for a sea vessel having a hull portion and a shutter door, the seal assembly closing a gap formed between the hull portion and shutter door.

(2) Description of the Prior Art

The current art for a sealing a gap 12 formed between an outer hull wall 14 and a shutter door 16 of a sea vessel is generally shown in FIG. 1 of the drawings. At present, a nominal gap 12 exists between the hull wall 14 and the shutter door 16. This gap 12 is sealed in the current art with a soft pliable hollow core type (extruded section) rubber seal 40. The rubber seal 40 is fastened to the hull wall 14 using a welded stud 42 secured with a washer 44 and nut 46 combination. A mating surface between the seal 40 and an inner surface of the hull wall 14 is filled with an adhesive (not shown).

This known arrangement has many limitations and disadvantages. In particular, as seawater flows along an outer surface of the hull 14 and closed shutter door 16, a negative pressure develops along the hull boundary layer. With a higher positive pressure (filled with seawater) residing in a shutter recess area 22, the existing flexible seal 40 with a very large surface area extrudes into the flow, releasing the water from the shutter recess area 22. A continuous flopping motion of the seal 40 results, causing the tearing of the hollow seal, further resulting in a noisy turbulent flow of water past the now-exposed gap 12.

An additional problem associated with this type of seal occurs when the shutter door 16 is open. The swing arc of the rotating shutter door 16 as it opens seaward is shown at 34. Under this condition, an extremely high velocity plume of water passes over the seal 40 just prior to and following a weapon launch. There is also the possibility of physical contact between a weapon being launched and the seal 40 itself. Any one of these conditions could result in seal failure. The ship cannot attain high speed and stealth capabilities with this type of seal.

The following patents, for example, disclose sealing systems but fail to disclose a shutter door seal system as disclosed herein.

U.S. Pat. No. 3,296,742 to Mortimer;

U.S. Pat. No. 3,396,712 to Sakraida et al.;

U.S. Pat. No. 3,913,971 to Green; and

U.S. Pat. No. 4,394,044 to Hough et al.

Specifically, Mortimer discloses a locking and sealing device having a rigid latch attached to one of the closure member and a surround member. The device is adapted to engage the other member to secure the closure member in a locked closed position. A sealing means, which is expandable and disposed around the closure member, is expandable to effect movement of the latch to a latch closing position, the sealing means being in the form of an inflatable tube which is located to seal a clearance around confronting surfaces of the closure member and surround member, the latch being pivotally movable by expansion of the inflatable tube to be brought into locking relation between the closure member and the surround member.

The patent to Sakraida et al. discloses a cover seal arrangement having a removable cylinder head cover including peripheral seal retaining means having a splash lip and a seal retaining groove receiving a resilient seal, the groove and seal being shaped to provide improved sealing ability with low seal compression combined with good retention of the seal in the groove.

Green discloses a detachable sun panel for the roof of an automobile consisting of a transparent panel supported on a resilient molding extending around the perimeter of an aperture formed in the roof. The molding is installed in a hole cut in a conventional roof and engages the sheet metal of the roof as well as the underlying headliner. The panel carries a pair of extensions on one end that engage the underside of the molding and a pair of latches on the opposite side which may be moved into a closed position to lock the panel against the molding.

Hough et al. discloses a removable sunroof panel adapted to be mounted in overlying relationship in an opening in the roof of a vehicle and includes front and rear mounting assemblies which allow either or both the front and rear of the panel to be held in an open position above the vehicle's roof. Each of the mounting assemblies includes a lever handle pivotally connected to the sunroof panel and a handle in a plurality of positions. A frame molding mounted in the sunroof opening includes a first section overlying the roof, and second and third sections below the roof defining a channel for receiving a resilient seal against which the roof panel seats; the second and third sections include a pair of opposed grooves for captivating a pair of ribs in the seal to retain the seal in the channel. An air deflector is mounted adjacent the leading edge of the sunroof opening in spaced relation to the leading edge and serves as a deflector for either redirecting air through the opening into the vehicle or preventing wind buffeting noise.

It should be understood that the present invention would in fact enhance the functionality of the above patents by providing a seal assembly combining a metal retainer and a resilient seal portion.

### SUMMARY OF THE INVENTION

Therefore it is an object of this invention to provide a seal assembly for an underwater vessel.

Another object of this invention is to provide a seal assembly that is durable in varying conditions.

Still another object of this invention is to provide a seal assembly for an underwater vessel that closes a gap between a hull wall and shutter door.

A still further object of the invention is to provide a sealing assembly including a metal retainer member and a resilient sealing member for closing the gap between the hull wall and shutter door.

In accordance with one aspect of this invention, there is provided a sealing assembly for closing a gap between a hull wall and a shutter door of a vessel. The sealing assembly includes a metal retainer member having a mounting block portion and a gap-closing portion extending from the mounting block portion. The mounting block portion is mounted to the hull wall and includes a slot formed therein parallel to the hull wall. The gap-closing portion has a tapered surface and a flat surface such that the flat surface is flush with sea-exposed surfaces of each of the hull wall and the shutter door. A resilient rubber member is provided having at least a part thereof secured within the slot of the mounting block portion and a remainder thereof secured to the tapered surface of the gap-closing portion of the retainer member with an adhesive. The resilient member fills the portion of the gap not closed by the gap-closing portion of the retainer.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is side sectional view of a prior art door seal; and

FIG. 2 is side sectional view of a sealing assembly according to a preferred embodiment of the present invention.

### DESCRIPTION OF THE PREFERRED EMBODIMENT

In general, the present invention is directed to an improved seal assembly 10 for an existing gap 12 between an outer non-pressure hull 14 of a ship and a torpedo tube shutter door 16 formed in the ship hull.

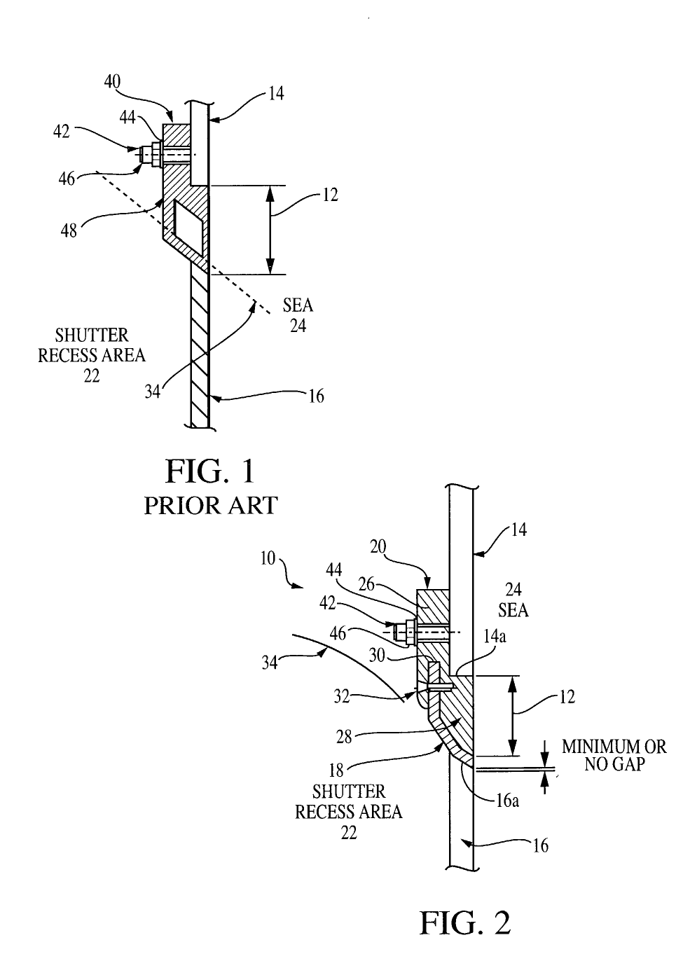

Referring again to FIG. 1, there is shown the prior art shutter door seal in a ship pressure hull. FIG. 2 shows the present invention, the seal assembly shown at 10 completely replacing the existing seal described in connection with FIG. 1 and any other known similar seal. The seal assembly 10 in FIG. 2 primarily includes a rubber seal member 18 and a metal retainer member 20.

As described in the Background above, a typical structure for an underwater portion of a vessel (not shown) includes the outer non-pressure hull portion 14 and the torpedo tube shutter door 16 that opens and closes in relation to the hull portion 14. The shutter door 16 is positioned so that there is a gap 12 from the distal end 16a of the shutter door 16 to the opposing end 14a of the hull wall 14. The purpose of the seal assembly 10 described herein is to close the gap 12 in a much more secure manner than previously known. As seen in FIG. 2, the combined hull wall 14, shutter door 16, and sealing assembly 10 provide a dividing wall between a shutter recess area 22 and a sea side 24 of the vessel. Although not part of the present invention, it will be understood that the purpose of the shutter door 16 is for the passage of a fired weapon such as a torpedo.

Continuing, the metal retainer member 20 is formed to substantially cover the existing gap 12 between the hull wall 14 and the shutter door 16. The metal retainer 20 is shaped so as to include a mounting block portion 26 and an extending portion 28. The mounting block portion 26 is securable to an inner surface of the hull wall 14 and the extending portion 28 extends beyond the end of the hull wall 14 and substantially fills the gap 12 with the exception of a very small area. That portion of the extending member 28 facing a sea side 24 of the vessel structure is conforming in surface shape to join the outer faces of the hull wall 14 and the shutter door 16 in an uninterrupted manner. In the example shown in FIG. 2, the outer surface is flat. That portion of the extending member 28 that faces the shutter recess area 22 of the vessel structure is fairly arcuate in shape so as to taper to a narrowest point just adjacent the distal end 16a of the shutter door 16. The distal end 16a of the shutter door 16 is angled so as to slant away from the recess shutter area 22. The taper in the extending portion 28 of the metal retainer 20 corresponds in shape to the slant at the distal end 16a of the shutter door 16.

The metal retainer 20 further includes a slot 30 where the mounting block portion 26 of the metal retainer 20 begins its taper. The rubber seal 18 is inserted into the slot 30 of the retainer 20 and secured thereto by adhesive (not shown) and any number of flathead screws 32 as are necessary to make the connection. Additionally, the remainder of the rubber seal 18 is adhered to the tapering portion 28 of the metal retainer 20 and terminates flush with the surface of the vessel on the sea side 24 thereof.

In order to install this new sealing assembly 10, it is only necessary to remove the existing seal assembly and replace it with the new sealing assembly 10. The existing self-locking nut 46, washer 44 and corresponding stud 42 can be reused to attach the mounting block portion 26 of the retainer 20 to the inner surface of the hull wall 14.

An arc of the rotated shutter door 16 is shown at 34. As the shutter door 16 rotates, it will clear the tapered portion 28 of the metal retainer 20 and brush against the rubber seal portion 18 of the seal assembly 10. After full rotation (to closure) of the shutter door 16, there will be a minimum or no gap 12 between the seal assembly 10 and shutter door 16. Further, the rubber seal portion 18 will be fully supported on both sides within the slot 30 of the metal retainer 20 of the seal assembly 10.

The rubber seal portion 18 of the described seal assembly 10 will not be subjected to the high loads known to exist in the rubber portion 40 of prior seals (see FIG. 1), but rather in the metal retainer 20 of the seal assembly 10. Therefore, the rubber portion 18 of the seal assembly 10 will not fail and leave the gap 12 exposed. If the rubber portion 18 of the present seal assembly 10 ever did fail, it would only leave-a small gap as reflected by the cross section of the rubber portion 18 of the seal assembly 10.

The present invention is highly advantageous over the known assemblies in that the metal retainer 20 fills the large gap 12 and supports the resilient portion 18 of the seal assembly in the high stress area. Further, there is a minimum or no gap between the seal assembly 10 and the shutter door 16. The resilient portion 18 of the seal assembly 10 will not extrude by design or flap back and forth, thereby eliminating the inherent high noise condition of the existing seal. With the new sealing assembly and installation thereof, the ship can now fully utilize its high speed and stealth design characteristics. Because of the design as a replacement part, there is a one to one replacement for existing ship components, thereby saving both time and cost.

In view of the above detailed description, it is anticipated that the invention herein will have far reaching applications other than those of a seal for closing the gap between the outer non-pressure hull and the torpedo tube shutter door of a vessel.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed is:

1. A sealing assembly comprising:
a retainer member having a mounting block and a tapered extending portion, the mounting block having a slot formed therein; and
a resilient member at least partially inserted into the slot of said retainer member and a remainder thereof secured to the tapered surface of the extending portion of said retainer member.

2. The assembly according to claim 1 wherein said retainer member is metal.

3. The assembly according to claim 1 wherein said resilient member is rubber.

4. The assembly according to claim 1 wherein said resilient member is secured in the slot with an adhesive.

5. The assembly according to claim 1 wherein said resilient member is secured in the slot with an adhesive and a screw.

6. The assembly according to claim 1 wherein said resilient member is secured to the tapered surface of the extending portion with an adhesive.

7. A sealing assembly for closing a gap between a hull wall and a shutter door of a vessel, said sealing assembly comprising:
a retainer member having a mounting block portion and a gap-closing portion extending from the mounting block portion, the mounting block portion being mounted to said hull wall, and the gap-closing portion having a tapered surface and a flat surface such that the flat surface is flush with sea exposed surfaces of each said hull wall and said shutter door; and
a resilient member having at least a part thereof secured to the mounting block portion of said retainer member and a remainder thereof secured to the tapered surface of the gap-closing portion of said retainer member, said resilient member filling that portion of said gap not closed by the gap-closing portion of said retainer.

8. The assembly according to claim 7 wherein said mounting block portion includes a slot formed therein substantially parallel to said hull wall.

9. The assembly according to claim 8 wherein the part of said resilient member secured to said mounting block portion is secured within the slot of said mounting block portion.

10. The assembly according to claim 9 wherein said resilient member is secured in the slot with an adhesive.

11. The assembly according to claim 9 wherein said resilient member is secured in the slot with an adhesive and a screw.

12. The assembly according to claim 9 wherein said resilient member is secured to the tapered surface of the extending portion with an adhesive.

13. The assembly according to claim 7 wherein said resilient member is rubber.
